(19) United States
(12) Patent Application Publication
(10) Pub. No.: US 2024/0005189 A1
(43) Pub. Date: Jan. 4, 2024

(54) TECHNIQUES OF QUANTUM COMPUTING MODEL

(71) Applicant: QULABZ INC., Kendall Park, NJ (US)

(72) Inventors: Nixon PATEL, Kendall Park, NJ (US); Goutam Kumar PAUL, Kolkata (IN); Kaushik NANDI, Kolkata (IN); Karthik KRISHNAKUMAR, Hyderabad (IN)

(21) Appl. No.: 17/993,696

(22) Filed: Nov. 23, 2022

(30) Foreign Application Priority Data
Nov. 24, 2021 (IN) 202131054346

(51) Int. Cl. G06N 10/20; G06N 10/40

(52) U.S. Cl. CPC G06N 10/20; G06N 10/40

(57) ABSTRACT

Techniques for providing an optimized quantum computing model are described. In operation, a gate teleportation circuit for a predetermined number of qubits is obtained. The gate teleportation circuit is then segmented into multiple sub-circuits. A gate teleportation operation is then performed on each of the multiple sub-circuits wherein the gate teleportation operation on each of the multiple sub-circuits is performed based on the at least one qubit of a given sub-circuit and an output of a gate teleportation operation performed on a sub-circuit which is previous to the given sub-circuit. An output of the gate teleportation operation performed on the last sub-circuit from the multiple sub-circuits is then measured.

### BACKGROUND

Quantum computing involves utilization of principles of quantum mechanics to perform complex computations. Devices that perform computations in quantum computing are known as quantum computing systems.

Quantum computing systems operate on quantum bits (or qubits) for manipulating information in quantum computing. A qubit is a basic building block for quantum information processing. The qubits are two-level quantum systems that are used to store and process quantum information. The qubits exist in superposition, i.e., the qubits can exist in two states simultaneously, thereby providing inherent parallelism in quantum computing.

A quantum computing system has three components which include a storage unit for housing the qubits, a method for transferring signal to the qubits, and a classical computing system to send instructions. Generally, the storage unit is kept at a temperature around absolute zero to maximize the coherence of the qubits and reduce interference. Further, signals are sent to the qubits using a variety of methods, such as microwaves or laser.

### BRIEF DESCRIPTION OF DRAWINGS

FIG. 1 illustrates schematics of a quantum computing system implementing an optimized quantum computing model, in accordance with an example of the present subject matter,

FIG. 2 illustrates a gate teleportation circuit, in accordance with an example of the present subject matter,

FIG. 3 illustrates a segmented gate teleportation circuit prepared in accordance with an example of the present subject matter, and

FIG. 4 illustrates a method for implementing the optimized quantum computing model, in accordance with an example of the present subject matter.

### DETAILED DESCRIPTION

Quantum computing systems utilize various quantum computing models that operate on qubits for realizations of quantum information processors. The quantum computing models utilize various quantum gates to manipulate information in quantum computing.

The quantum gates act on qubits to alter the state of the qubit, where the alteration of the state of qubit generally corresponds to the rotation of the qubits in Bloch Sphere. The Bloch sphere is a geometric representation of qubit states as points on the surface of a unit sphere. There are certain criteria that a quantum gate must satisfy to be a valid operation, one of which is that the quantum gate must be a unitary matrices to ensure that the modulus of the qubit does not change. The quantum gates are analogous to logic gates in classical computers as the quantum gates operate in a similar manner to gates, such as the ‘NOT’, ‘AND’, and ‘OR’ gates, operate in classical computers.

Quantum gates are primarily classified into two categories, i.e., single qubit gates and multi-qubit gates. An example of single qubit gate is Pauli gate. There are three Pauli Gates, i.e., X, Y, and Z, where each of the Pauli gates X, Y, Z correspond to the measurement operators in each of the basis directions respectively. A Pauli gate along with identity gate provides a generator of all possible operations on a single qubit. The matrix representations and circuit representations of the Pauli gates X, Y, and Z are provided in the Table 1:

TABLE 1

| | | | |
|---|---|---|---|
| Pauli-X (X) | 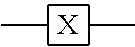 | 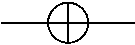 | $[ \begin{matrix}0 & 1 \\ 1 & 0\end{matrix} ]$ |
| Pauli-Y (Y) | 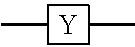 | | $[ \begin{matrix}0 & - 1 \\ 1 & 0\end{matrix} ]$ |
| Pauli-Z (Z) | 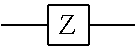 | | $[ \begin{matrix}1 & 0 \\ 0 & - 1\end{matrix} ]$ |

Another example of single qubit gate is a Hadamard gate. The Hadamard gate acts as a transformation from Z-computational basis to X-computational basis and vice versa. Hadamard gates are particularly important for several quantum techniques as when Hadamard gates are acted on multiple qubits, an equal superposition of all basis states is obtained. An action of the Hadamard gate on the basis states and a matrix representation of the same is in the Table 2:

TABLE 2
$H \vert 0 〉 \to \frac{\vert 0 〉 + \vert 1 〉}{2}$
$H \vert 1 〉 \to \frac{\vert 0 〉 - \vert 1 〉}{2}$

| | | |
|---|---|---|
| Hadamard (H) | 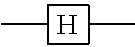 | $\frac{1}{\sqrt{2}} [ \begin{matrix}1 & 1 \\ 1 & - 1\end{matrix} ]$ |

Single qubit Gates are not sufficient to describe all possible actions on a system of qubits. Thus, similar to 2-bit logical gates in classical computing, such as AND gates and OR gates, there exists multi-qubit gates in quantum computing. An example of multi-qubit gate is a Controlled-Not gate. In the controlled Not gate, one qubit acts as a control qubit and the other qubit acts as a target qubit. The action on the target qubit is conditional on the state in the control qubit. If the Control Qubit is in state |0 [symbol] , then there exists no action on the target qubit and if the target qubit is in the state |1 [symbol] then a X Pauli operation is performed on the target qubit. The Controlled-Not gate along with the Pauli gates forms a Universal Gate Set.

Another notable example of the multi-qubit gate are Swap gates and Toffoli gates. The Swap gate exchanges the state between two wires in a circuit and the Toffoli gate acts as a controlled swap gate similar to the Controlled Not gate. The matrix representations of the Controlled-Not gate, swap gate, and the Toffoli gate are provided in Table 3:

TABLE 3

| | | | |
|---|---|---|---|
| Controlled Not (CNOT, CX) | 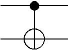 | | $[ \begin{matrix}1 & 0 & 0 & 0 \\ 0 & 1 & 0 & 0 \\ 0 & 0 & 0 & 1 \\ 0 & 0 & 1 & 0\end{matrix} ]$ |
| SWAP | 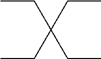 | 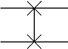 | $[ \begin{matrix}1 & 0 & 0 & 0 \\ 0 & 0 & 1 & 0 \\ 0 & 1 & 0 & 1 \\ 0 & 0 & 0 & 0\end{matrix} ]$ |
| Toffoli (CCNOT, CCX, TOFF) | 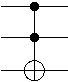 | | $[ \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 0 & 1 \\ 0 & 0 & 0 & 0 & 0 & 0 & 1 & 0\end{matrix} ]$ |

One of the various quantum computing models that utilizes the afore-mentioned quantum gates for realisations of quantum information processors is circuit model. In the circuit model of quantum computing, a number of qubits initialized in the |0 [symbol] state, are taken as the input state. The qubits are then allowed to undergo various one-qubit and two qubit operations before being measured. Usually, quantum computation in circuit model represents unitary operations which can be decomposed into controlled-NOT gates and single qubit (more specifically, special unitary gates, SU(2)) gates. However, in the circuit model of quantum computing, the number of the qubit gates required for a given quantum operation grows exponentially with the circuit. This in turn affects the efficiency of the computational task.

An alternative to the circuit model of quantum computing is Measurement Based Quantum Computing (MBQC) model. In the MBQC model, the initial state preparation for MBQC is based on the concept of gate teleportation. The gate teleportation circuit facilitates transfer of an unknown quantum state to another qubit in the MBQC model. In the MBQC model, performing the gate teleportation involves supplying all the qubits involved in computation in a highly entangled state, also known as cluster state. The highly entangled state is obtained by preparing each of the ‘n’ qubits in |+ [symbol] ={|0 [symbol] +|1 [symbol] }/√2 state followed by application of controlled gates between qubits whose corresponding graph vertices are connected. However, as the number of qubits involved in computation are increased, the computational complexity involved in entanglement of the qubits increases. Also, the preparation of the highly entangled state entails the involvement of all the ‘n’ qubits, thereby increasing the consumption of computational resources in the implementation of the MBQC model. Accordingly, the operational efficiency involved in the implementation of the quantum computing systems is degraded.

According to example implementations of the present subject matter, techniques for providing an optimized quantum computing model are described.

In an example, the techniques involve conceding on the demands of having a highly pre-entangled state of qubits and performing the gate teleportation operations sequentially.

In an example implementation, a gate teleportation circuit for a predetermined number of qubits is obtained. In an example, the gate teleportation circuit for the predetermined number of qubits may be prepared based on a Measurement Based Quantum Computing (MBQC) model. The gate teleportation circuit is then segmented into multiple sub-circuits to process the qubits sequentially. In an example, the gate teleportation circuit may be segmented into multiple sub-circuits based on the number of qubits in the gate teleportation circuit. A gate teleportation operation may then be performed in a first sub-circuit from the multiple sub-circuits and an output of the first sub-circuit may be inputted to a forthcoming subcircuit, i.e., a second sub-circuit of the multiple sub-circuits. The process of performing the gate teleportation operation on a sub-circuit from the multiple sub-circuits and inputting the output of the gate teleportation operation on the sub-circuit to a forthcoming sub-circuit may be repeated until all the sub-circuits have been traversed. An output of the computation may then be measured from the last sub-circuit of the multiple sub-circuits.

Segmenting the gate teleportation circuit for qubits into multiple sub-circuits and performing the gate teleportation operations on the multiple sub-circuits sequentially reduces the computational complexity involved in preparation of the entangled state of all the involved qubits, thereby enhancing the overall operational efficiency of the quantum computing system employing the optimized quantum computing model. Further, as output for each of the multiple sub-circuits is fed into forthcoming sub-circuits as soon as gate teleportation operation is complete for each of the multiple sub-circuits, duration for which qubits are to be maintained in their states is also reduced, thereby reducing the consumption of computational resources of the quantum computing system. Moreover, the sequential gate teleportation operation entails only a subset of total qubits involved in computation to be used at once, thereby allowing reusability of qubits.

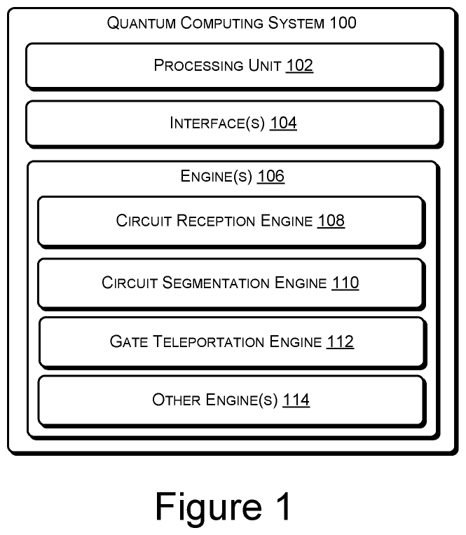

The above techniques are further described with reference to FIG. 1 to FIG. 4. It should be noted that the description and the figures merely illustrate the principles of the present subject matter along with examples described herein and should not be construed as a limitation to the present subject matter. It is, thus understood that various arrangements may be devised that although not explicitly described or shown herein, statements herein reciting principles, aspects, and implementations of the present subject matter, as well as specific examples thereof, are intended to encompass equivalents thereof.

FIG. 1 illustrates a quantum computing system 100 for implementing the optimized quantum computing model, in accordance with an example of the present subject matter. For the ease of reference, the quantum computing system 100 has been referred to as system 100, hereinafter. The system 100 may include a processing unit 102, interfaces 104 and engines 106. The processing unit 102 may include qubit processors or similar circuitry which may be implementing a quantum qubit processor. The interfaces 104 enable communication of the signals or data between different logical layers (not depicted for sake of brevity) constituting the quantum computing system 100. It may be noted that the system 100 may include further supporting infrastructure, hardware and accompanying equipment and classical processing machines, collectively functioning for implementing the quantum computing system 100. These are also not depicted for sake of brevity and for ease in explanation.

The engines 106 may be implemented as a combination of hardware and programming, for example, programmable instructions to implement a variety of functionalities. In examples described herein, such combinations of hardware and programming may be implemented in several different ways. For example, the programming for the engines 106 may be executable instructions. In an example, the engines 106 may include a processing resource, for example, either a single processor or a combination of multiple processors, to execute one or more instructions. In the present examples, the non-transitory machine-readable storage medium may store instructions, that when executed by the processing resource, implement engines 106. In other examples, the engines 106 may be implemented as electronic circuitry.

The engine 106 may further include a circuit reception engine 108, a circuit segmentation engine 110, a gate teleportation engine 112, and other engines 114.

In operation, the circuit reception engine 108 may obtain a gate teleportation circuit for a particular number of qubits. In an example, the gate teleportation engine may be prepared based on Measurement Based Quantum Computing (MBQC) model. The gate teleportation circuit is a circuit that is utilized for transferring an unknown quantum state of a qubit to another qubit. For instance, in an example, an unknown qubit (|ψ [symbol] =α|0 [symbol] +β|1 [symbol] ) may be encoded in a line with another qubit in |+ [symbol] state. These two qubits may be connected to each other through Controller Z (CZ) gates. The final state that is obtained after the operation of the CZ gate is,

|ψ″ [symbol] =α|0+ [symbol] +β|1− [symbol] (1)

In equation 1, measuring the first qubit in the Me basis, results the unknown qubit in the state |ψ [symbol] f=X^{s}J_{-θ}|ψ [symbol] . In the example, the gate teleportation circuit for the particular number of qubits may be prepared in a similar manner.

Subsequently, the circuit segmentation engine 110 may segment the gate teleportation circuit into multiple sub-circuits. The circuit segmentation engine 110 may segment the gate teleportation circuit into multiple sub-circuits based on the number of qubits in the gate teleportation circuit. For instance, the circuit segmentation engine 110 may determine the number of sub-circuits segmented from the gate teleportation circuit based on the number of qubits in the gate teleportation circuit.

In an example, if the number of qubits included in the gate teleportation circuit is equal to ‘2ⁿ’, the circuit segmentation engine 110 may segment the gate teleportation circuit into multiple sub-circuits, where each of the multiple sub-circuits has ‘n’ qubits. For instance, if the number of qubits included in the gate teleportation circuit is ‘16’, the circuit segmentation engine 110 may segment the gate teleportation circuit into multiple sub-circuits, with each of the multiple sub-circuit having ‘4’ qubits. Accordingly, if the number of qubits included in the gate teleportation circuit is ‘16’, the gate teleportation engine 110 may segment the gate teleportation circuit into ‘4’ sub-circuits.

In another example, if the number of qubits included in the gate teleportation circuit is greater than ‘2ⁿ’ but less than 2ⁿ⁺¹, the circuit segmentation engine 110 may segment the gate teleportation circuit into multiple sub-circuits, where each of the multiple sub-circuits has ‘n+1’ qubits. For instance, if the number of qubits included in the gate teleportation circuit is ‘12’, the circuit segmentation engine 110 may segment the gate teleportation circuit into multiple sub-circuits, with each of the multiple sub-circuits having ‘4’ qubits (since 2³<12<2⁴). Accordingly, if the number of qubits included in the gate teleportation circuit is ‘16’, the gate teleportation engine 110 may segment the gate teleportation circuit into ‘3’ sub-circuits.

The gate teleportation engine 112 may then perform a gate teleportation operation on a first sub-circuit of the five sub-circuits and obtain a first output. Thereafter, the gate teleportation engine 112 may input the first output into a second sub-circuit of the five sub-circuits. The gate teleportation engine 112 may subsequently perform another gate teleportation operation on the second sub-circuit based on the input received from the first sub-circuit, i.e., first output, and the qubits included in the second sub-circuit. The gate teleportation engine 112 may similarly perform the gate teleportation operations on rest of the sub-circuits till all the sub-circuits obtained from the segmentation of the gate teleportation circuit are traversed. The gate teleportation engine 112 may then measure the final output from the last teleportation circuit.

In an example implementation, the optimized quantum computing model may be utilized for implementation of Grover's algorithm. The Grover's Algorithm is a quantum algorithm that is utilized for performing a search on an unstructured database. In other words, the Grover's algorithm may be utilized while a search is to be conducted for a particular item in a list of ‘N’ items placed in a scattered manner. To find the particular item in the list, most of the classical computing algorithms compare the particular item with every item in the list one after the other, which requires at least ‘N/2’ comparisons to find the particular item in the list. In worst case scenarios, the classical computing algorithms may end up comparing the particular item with all the ‘N’ items in the list. On the contrary, utilizing the Grover's Algorithm on a quantum computer, the particular item may be found in the list of ‘N’ items in roughly ‘√N’ comparisons.

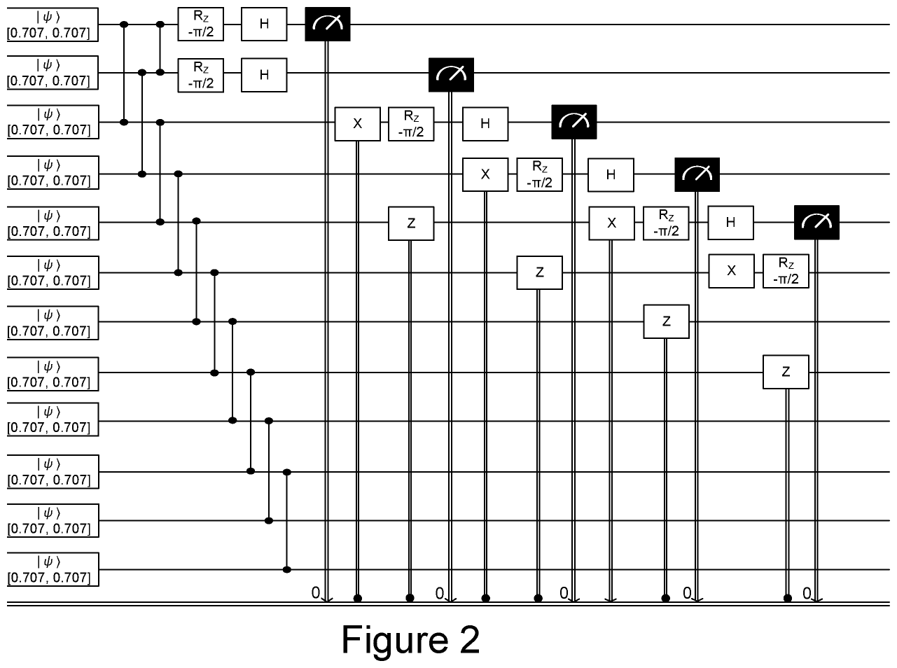

In an example of the present subject matter, the Grover's algorithm may be implemented for ‘12’ qubits at a time. In operation, the circuit reception engine 108 may obtain a gate teleportation circuit for the ‘12’ qubits, the gate teleportation circuit for the ‘12’ qubits being prepared based on the MBQC model. An exemplary gate teleportation circuit obtained by the circuit reception engine 108 for ‘12’ qubits is illustrated in FIG. 2. The ‘12’ qubits may include q0₀, q0₁, q0₂, q0₃, q0₄, q0₅, q0₆, q0₇, q0₈, q0₉, q0₁₀, and q0₁₁. In an example, each of the ‘12’ qubits may be operated upon by various quantum gates and a basis state for each qubit may be measured. In said example, the basis states for each of the qubits may then be superimposed to obtain a final quantum state, where the quantum state may represent a solution to a quantum algorithm being operated upon by a quantum computing system.

Subsequently, the circuit segmentation engine 110 may segment the gate teleportation circuit into multiple sub-circuits. As already described, the circuit segmentation engine 110 may segment the gate teleportation circuit into multiple sub-circuits based on in the number of qubits included in the gate teleportation circuit. Accordingly, the circuit segmentation engine 110 may segment the gate teleportation circuit into ‘3’ sub-circuits, with each sub-circuit having 4 qubits.

The gate teleportation engine 112 may then perform a gate teleportation operation on a first sub-circuit of the ‘3’ sub-circuits and obtain a first output. In an example, the ‘4’ qubits included in the first sub-circuit may be q0₀, q0₁, q0₂, and q0₃, where the qubits q0₀ and q0₂ may be input qubits and q0₁ and q0₃ may be output qubits. In said example, to perform the gate teleportation operation on the first sub-circuit, the gate teleportation engine 112 may begin with qubits q0₀, q0₁, q0₂, and q0₃ in the state |0>, thereby obtaining the state |ψ0>=|0>|0>|0>|0>. Specifically, the gate teleportation engine 112 may begin with an empty circuit with all qubits initialized in the state ‘0’. A state vector corresponding to the above-mentioned state of qubits may be described by an array shown below:

Statevctor=[1 0 0 0 . . . 0 0 0]

Thereafter, the gate teleportation engine 112 may apply Hadamard operation on all the ‘4’ qubits to take the qubits to an equal superposition of all states in computational basis. The initial superposition of all the states so obtained may be described as follows:

$$\vert + > \vert + > \vert + > \vert + > = \frac{1}{4} [ ( \vert 0 > + \vert 1 > ) * ( \vert 0 > + \vert 1 > ) * ( \vert 0 > + \vert 1 > ) * ( \vert 0 > + \vert 1 > ) ]$$

A state vector corresponding to the above-mentioned state of qubits may be described by an array shown below:

$$Statevector = [ \frac{1}{4} \frac{1}{4} \frac{1}{4} \frac{1}{4} … \frac{1}{4} \frac{1}{4} \frac{1}{4} ]$$

Thereafter, the gate teleportation engine 112 may apply CZ operations between the qubits q0₀ and q0₁. This, in turn, may lead to action of Z gate on the |1>|0>, |1>|1> part of the state which leads to the −ve sign on amplitude corresponding to |1>|1>. The state so obtained may be described as follows:

$$\frac{1}{4} [ ( \vert 0 > \vert 0 > + \vert 0 > \vert 1 > + \vert 1 > \vert 0 > - \vert 1 > \vert 1 > ) * ( \vert 0 > \vert 0 > + \vert 0 > \vert 1 > + \vert 1 > \vert 0 > + \vert 1 > \vert 1 > ) ]$$

A state vector corresponding to the above-mentioned state of qubits may be described by an array shown below.

$$Statevector = [ \text{} \frac{1}{4} \frac{1}{4} \frac{1}{4} - \text{} \frac{1}{4} \frac{1}{4} \frac{1}{4} \frac{1}{4} - \frac{1}{4} \frac{1}{4} \frac{1}{4} \frac{1}{4} \frac{1}{4} - \frac{1}{4} \frac{1}{4} \frac{1}{4} \frac{1}{4} \frac{1}{4} ]$$

Subsequently, the gate teleportation engine 112 may apply CZ operations between the input qubits and output qubits. This may lead to addition of a −ve sign to the terms corresponding to the |1>|1>. Thus, an additional −ve sign may be seen added to the terms having q0q2 in |1>1> state. Similarly, an additional −ve sign may also be added to the terms having q1q3 in |1>1> state. A state vector corresponding to the above-mentioned state of qubits may be described by an array shown below:

$$Statevector = [ \text{} \frac{1}{4} \frac{1}{4} \frac{1}{4} - \text{} \frac{1}{4} \frac{1}{4} - \frac{1}{4} \frac{1}{4} \frac{1}{4} \frac{1}{4} \frac{1}{4} - \frac{1}{4} \frac{1}{4} \frac{1}{4} - \frac{1}{4} - \frac{1}{4} - \frac{1}{4} ]$$

The gate teleportation engine 112 may then apply a −pi/2 rotation and Hadamard operator on the input qubits. This, in turn, may lead to the qubits wind into the state described by array provided below:

$$Statevector = [ \frac{1}{4} ( 1 + i ) 00 \frac{1}{4} ( - 1 + i ) 0 \frac{1}{4} ( 1 + i ) \frac{1}{4} ( - 1 + i ) 00 \frac{1}{4} ( - 1 + i ) \frac{1}{4} ( 1 + i ) 00 \frac{1}{4} ( 1 + i ) ]$$

The gate teleportation engine 112 may then perform the measurement of the input qubits q0₀ and q0₂ and apply corresponding corrections on the output qubits to receive a final state vector provided below

$$Statevector = [ \frac{1}{2} ( 1 + i ) 000000000000 \frac{1}{2} ( - 1 + i ) 000 ]$$

The gate teleportation engine 112 may then decompose the above-mentioned state vector to get the following state:

$$\vert output >= [ ( \vert 0 > \vert 0 > ) * \frac{1}{2} ( \{ 1 + i \} \vert 00 > + \{ - 1 + i \} \vert 11 > ) \qquad ( 2 )$$

The gate teleportation engine 112 may then input the first output, i.e., equation 2, into a second sub-circuit of the ‘3’ sub-circuits. The gate teleportation engine 112 may then perform another gate teleportation operation on the second sub-circuit based on the input received from the first sub-circuit, i.e., first output, and the qubits included in the second sub-circuit, i.e., q0₄, q0₅, q0₆, and q0₇.

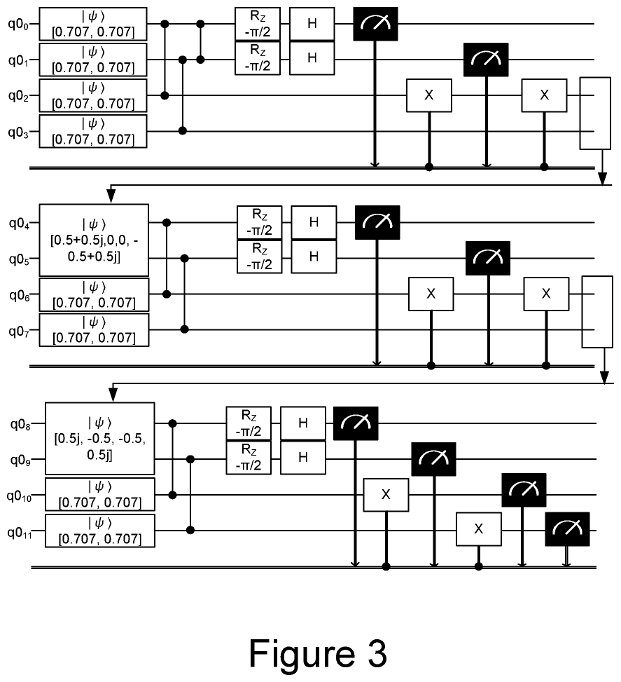

As illustrated in FIG. 3, the gate teleportation engine 112 may similarly perform the gate teleportation operations on rest of the sub-circuits till all the sub-circuits obtained from the segmentation of the gate teleportation circuit are traversed. In an example, the gate teleportation engine 112 performs the gate teleportation operation on the rest of the sub-circuits in a manner similar to the first sub-circuit. Accordingly, the details related to the manner in which the gate teleportation engine 112 performs gate teleportation operation on the rest of the sub-circuits is not described herein for the sake of brevity. The gate teleportation engine 112 may subsequently measure the final output from the last teleportation circuit.

Segmenting the gate teleportation circuit into multiple sub-circuits and performing the gate teleportation operations on the multiple sub-circuits sequentially reduces the computational complexity involved in preparation of the entangled state of all the involved qubits, thereby enhancing the overall operational efficiency of the quantum computing system employing the optimized quantum computing model. Further, as output for each of the multiple sub-circuits is fed into forthcoming sub-circuits as soon as gate teleportation operation is complete for each of the multiple sub-circuits, duration for which qubits are to be maintained in their states is also reduced, thereby reducing the consumption of computational resources of the quantum computing system. Moreover, the sequential gate teleportation operation entails only a subset of total qubits involved in computation to be used at once, thereby allowing reusability of qubits.

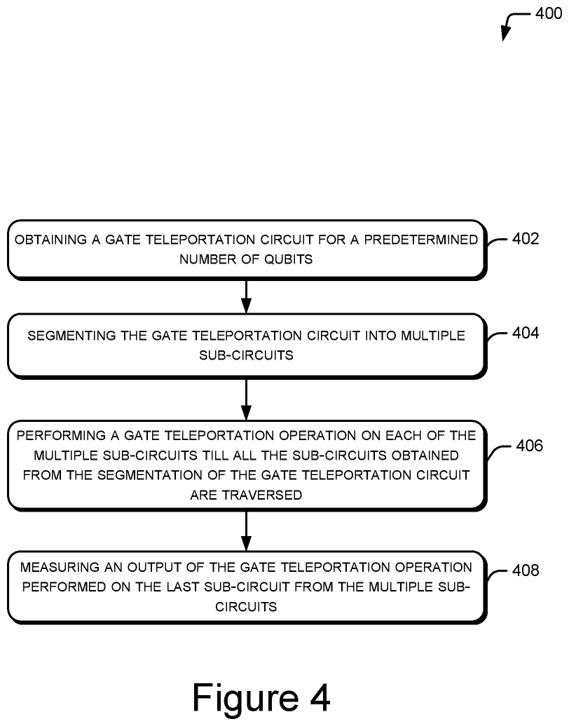

FIG. 4 illustrates a method for implementing the optimized quantum computing model, in accordance with an example of the present subject matter. Although the method 400 may be implemented in a variety of devices, but for the ease of explanation, the description of the method 400 is provided in reference to the above-described quantum computing system 100. The order in which the method 400 is described is not intended to be construed as a limitation, and any number of the described method blocks may be combined in any order to implement the method 400, or an alternative method.

It may be understood that blocks of the method 400 may be performed in the quantum computing system 100. The blocks of the method 400 may be executed based on instructions stored in a non-transitory computer-readable medium, as will be readily understood.

At block 402, a gate teleportation circuit for a predetermined number of qubits may be obtained. In an example, the obtained gate teleportation circuit may be prepared based on the MBQC model. In said example, the gate teleportation circuit may be received by a circuit reception engine 108 of the quantum computing system 100.

At block 404, the gate teleportation circuit may be segmented into multiple sub-circuits. In an example, the gate teleportation circuit may be segmented into multiple sub-circuits based on the number of qubits included in the gate teleportation circuit. For instance, the number of sub-circuits segmented from the gate teleportation circuit may be determined based on the number of qubits in the gate teleportation circuit. In an example, if the number of qubits included in the gate teleportation circuit is equal to ‘2ⁿ’, the gate teleportation circuit may be segmented into multiple sub-circuits, where each of the multiple sub-circuits has ‘n’ qubits. In another example, if the number of qubits included in the gate teleportation circuit is greater than ‘2ⁿ’ but less than ‘2ⁿ⁺¹’, the gate teleportation circuit may be segmented into multiple sub-circuits, where each of the multiple sub-circuits has ‘n+1’ qubits. Further, in said example, the gate teleportation circuit may be segmented into multiple sub-circuits by a circuit segmentation engine 110 of the quantum computing system 100.

At block 406, a gate teleportation operation may be performed on each of the multiple sub-circuits till all the sub-circuits obtained from the segmentation of the gate teleportation circuit are traversed. In an example, the gate teleportation operation for each of the multiple sub-circuits may be performed based on an output of a gate teleportation operation performed on a previous sub-circuits and the qubits included in each of the multiple sub-circuits. In an example, the gate teleportation operation may be performed on each of the multiple sub-circuits by the gate teleportation engine 112.

At block 408, an output of the gate teleportation operation performed on the last sub-circuit from the multiple sub-circuits may be measured. In an example, the output of the gate teleportation operation performed on the last sub-circuit may be measured by the other engine 114.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method comprising:
obtaining a gate teleportation circuit for a predetermined number of qubits, wherein the gate teleportation circuit is to transfer an unknown quantum state of a qubit to another qubit in a quantum computing model;
segmenting the gate teleportation circuit into a plurality of sub-circuits based on the predetermined number of qubits, wherein each of the plurality of sub-circuits comprises at least one qubit;
performing a gate teleportation operation on each of the plurality of sub-circuits sequentially, wherein the gate teleportation operation on each of the plurality of sub-circuits is performed based on the at least one qubit of a given sub-circuit and an output of a gate teleportation operation performed on a sub-circuit which is previous to the given sub-circuit; and
measuring an output of the gate teleportation operation on a last sub-circuit from the plurality of sub-circuits.

2. The method as claimed in claim 1, wherein the gate teleportation circuit is prepared based on Measurement Based Quantum Computing (MBQC) model.

3. The method as claimed in claim 1, wherein each of the plurality of sub-circuits comprises ‘n’ qubits when the predetermined number of qubits is 2ⁿ.

4. The method as claimed in claim 1, wherein each of the plurality of sub-circuits comprises ‘n+1’ qubits when the predetermined number of qubits is more than 2ⁿ and less than 2ⁿ+1.

5. A quantum computing system comprising:
a circuit reception engine to obtain a gate teleportation circuit for a predetermined number of qubits, wherein the gate teleportation circuit is utilized for transferring an unknown quantum state of a qubit to another qubit in a quantum computing model;
a circuit segmentation engine coupled to the circuit reception engine to segment the gate teleportation circuit into a plurality of sub-circuits based on the predetermined number of qubits, wherein each of the plurality of sub-circuits comprises at least one qubit; and
a gate teleportation engine coupled to the circuit segmentation engine to:
perform a gate teleportation operation on each of the plurality of sub-circuits sequentially, wherein the gate teleportation operation on each of the plurality of sub-circuits is performed based on an at least one qubit of a given sub-circuit and an output of a gate teleportation operation performed on a sub-circuit which is previous to the given sub-circuit; and
measure an output of the gate teleportation operation on a last sub-circuit from the plurality of sub-circuits.

6. The quantum computing system as claimed in claim 5, wherein the gate teleportation circuit is prepared based on Measurement Based Quantum Computing (MBQC) model.

7. The quantum computing system as claimed in claim 5, wherein each of the plurality of sub-circuits comprises ‘n’ qubits when the predetermined number of qubits is 2ⁿ.

8. The quantum computing system as claimed in claim 5, wherein each of the plurality of sub-circuits comprises ‘n+1’ qubits when the predetermined number of qubits is more than 2ⁿ and less than 2ⁿ+1.
